(19) United States
(12) Patent Application Publication
(10) Pub. No.: US 2023/0090150 A1
(43) Pub. Date: Mar. 23, 2023

(54) SYSTEMS AND METHODS TO OBTAIN SUFFICIENT VARIABILITY IN CLUSTER GROUPS FOR USE TO TRAIN INTELLIGENT AGENTS

(71) Applicant: International Business Machines Corporation, Armonk, NY (US)

(72) Inventors: Brandon Harris, Union City, NJ (US); Chaz Vollmer, Raleigh, NC (US); Eugene Irving Kelton, Wake Forest, NC (US)

(21) Appl. No.: 17/482,968

(22) Filed: Sep. 23, 2021

(51) Int. Cl. G06K 9/62; G06N 20/00; G06F 11/36; G06Q 20/40

(52) U.S. Cl. CPC G06K 9/6265; G06K 9/6221; G06K 9/6249; G06K 9/6251; G06N 20/00; G06F 11/3692; G06Q 20/4016

(57) ABSTRACT

A method, system, and computer programming product for checking that clusters representative of transactional activity of a group of persons exhibits sufficient variability including: receiving transactional data; forming clusters from the received transactional data representing groups of persons that behave similarly; determining that a cluster representing a group of persons that behave similarly is not sufficiently variable; and increasing, in response to the cluster representing the group of persons behaving similarly not being sufficiently variable, the variability of the cluster. Further including, in an embodiment, creating a superset cluster consisting of both the cluster and the parent of the cluster; creating test data using the superset as a baseline; injecting the test data into the superset cluster; determining if the superset cluster rejects the injected test data as an indication of insufficient variability.

### TECHNICAL FIELD

The present invention relates generally to clustering data, e.g., transactional data, for use, for example, for training intelligent agents or bots and performing cognitive analytics.

### BACKGROUND

Systems and methods have been developed that use cognitive analytics to help financial institutions, e.g., banks, to detect suspicious activity indicative of money laundering, terrorist financing, and/or fraudulent activity. The cognitive analytics differentiate “normal” financial activities from “suspicious” activities, and use the differentiation information to build a predictive model for financial institutions. One example of a financial crime detection system that uses cognitive analytics to help financial institutions detect suspicious activity is IBM® Financial Crimes Alerts Insight with Watson™. Other cognitive analytical models and methods exist to attack and solve the problem of detecting suspicious activity indicative of money laundering, terrorist financing, and other fraudulent activity, and each have their merits and detriments.

Current systems to detect suspicious activity typically rely upon real customer data from financial institutions. The problem with relying on real customer data for analytics is that the data is very difficult to access and use in testing and development environments due to the sensitive and private nature of the data (personally identifying information (PII), financial behavior information, etc.). In addition, when real data is available, it is finite and its use in creating analytics is limited (difficult to “transfer” to other use cases, or use to predict future, unseen behavior). Past methods to address privacy concerns include data cleansing, anonymizing, or hashing, but these methods further limit the usefulness of the data. It would be advantageous to generate simulated data that generalizes and/or summarizes customer behavior for effectiveness to help agent training. It would be advantageous to provide clusters of data representative of individuals or entities that meet minimum standards of variability so that the clusters are more meaningful and have appropriate entropy to assist in agent training.

### SUMMARY

The summary of the disclosure is given to aid understanding of, and not with an intent to limit, the disclosure. The present disclosure is directed to a person of ordinary skill in the art. It should be understood that various aspects and features of the disclosure may advantageously be used separately in some circumstances or instances, or in combination with other aspects, embodiments, and/or features of the disclosure in other circumstances or instances. Accordingly, variations and modifications may be made to the system, the platform, the architectural structure, and/or methods described to achieve different effects. In this regard it will be appreciated that the disclosure presents and describes one or more inventions, and in aspects includes numerous inventions as defined by the claims.

A system, computer program product, and/or method is disclosed for providing clusters having sufficient variability to train intelligent agents (e.g., intelligent bots) to simulate a person's (individual or entity) behavior. A trained intelligent agent in one or more embodiments predicts behavioral patterns, and in an aspect (transactional) activity of one or more persons, e.g., one or more simulated persons (e.g., a set of simulated persons). A cluster can represent in an embodiment a set of transactional behavior parameters. It is beneficial that the clusters that are representative of individuals or entities have sufficient variability or entropy in their data set so that the intelligent agents that are trained are representative of the individual or entity. In one more embodiments, the system, platform, computer program product, and/or method for checking that clusters representative of transactional activity of persons or groups of persons exhibit sufficient variability including a processor and a memory having instructions, which are executed by the processor to cause the processor to implement the method, the method including: receiving transactional data; forming clusters from the received transactional data representing groups of persons that behave similarly; determining that a cluster representing a group of persons that behave similarly is not sufficiently variable; and increasing, in response to the cluster representing the group of persons behaving similarly not being sufficiently variable, the variability of the cluster. According to an approach forming clusters from the received transactional data representing groups of persons behaving similarly includes performing an unsupervised learning analysis process on the received transactional data and according to further aspect includes performing multiple unsupervised learning analysis processes including performing an unsupervised learning analysis process on one or more clusters.

According to one or more embodiments, determining that a cluster representing a group of persons that behave similarly is not sufficiently variable includes: creating a superset cluster consisting of both the cluster and the parent of the cluster by performing a series of statistical analyses and normalization functions; creating test data using the superset as a baseline; injecting the test data into the superset cluster; determining if the superset cluster rejects the injected test data; and rejecting, in response to the superset rejecting the injected test data, the cluster as not sufficiently variable. In an aspect, the test data is half a standard deviation off the superset cluster. In a further approach final statistical analysis is performed on each of the clusters. In a further aspect the method includes determining that a cluster has sufficient variability and performing final statistical analysis of the cluster. In an embodiment increasing the variability of the cluster further includes merging the cluster with one or more other, different clusters. The another, different cluster in an embodiment is selected from a group of clusters that are formed from a parent cluster of the cluster and/or is selected to have the greatest variability. The method according to an embodiment includes using the clusters with increased variability to train intelligent agents used to simulate the transactional behavior of a person or a group of persons. Each cluster in an aspect has parameters including a minimum transactional amount, a maximum transactional amount, a minimum number of transactions in an iteration, and a maximum number of transactions in the iteration. The cluster having insufficient variability in an embodiment is dropped as a cluster.

A computer program product is disclosed having programming instructions embedded for example on a processor readable storage medium, the program instructions executable by a processor to cause the processor to perform as described herein. A system for increasing the variability in clusters formed to represent the transactional activity of a person or group of persons is disclosed, the system including a computer readable non-transitory storage medium having program instructions embedded therewith; and a processor configured to execute said program instructions to cause the processor to: receive transactional data; form, using an unsupervised learning process, clusters from the received transactional data that represent groups of persons that behave similarly; determine that a cluster representing a group of persons that behave similarly is not sufficiently variable; increase, in response to each cluster representing a group of persons behaving similarly that is not sufficiently variable, the variability of each such cluster that is not sufficiently variable; and perform statistical analysis of each cluster. In an approach the program instructions executable by the processor to cause the processor to determine that a cluster representing a group of persons behaving similarly is not sufficiently variable further includes instructions executable by the processor to cause the processor to: create a superset cluster consisting of both the cluster and the parent of the cluster by performing a series of statistical analyses and normalization functions; create test data that is half a standard deviation off of the superset cluster; injecting the test data into the superset cluster; determining if the superset cluster rejects the injected test data; and rejecting, in response to the superset rejecting the injected test data, the cluster as not sufficiently variable.

The foregoing and other objects, features, and/or advantages of the invention will be apparent from the following more particular descriptions and exemplary embodiments of the invention as illustrated in the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. The claims should not be limited to the precise arrangement, structures, systems, platforms, architectures, modules, functional units, assemblies, subassemblies, systems, circuitry, embodiments, programming, features, aspects, methods, processes, techniques, devices and/or details shown, and the arrangements, structures, systems, circuitry, platforms, architectures, modules, functional units, assemblies, subassemblies, features, aspects, programming, methods, processes, techniques, embodiments, devices and/or details shown may be used singularly or in combination with other arrangements, structures, assemblies, subassemblies, systems, circuitry, platforms, architectures, modules, functional units, features, aspects, programming, embodiments, methods, techniques, processes, devices and/or details. The accompanying drawings include the following figures where:

FIG. 1 depicts a schematic diagram of one illustrative implementation of a cognitive system 100 implementing transaction data simulator and behavioral pattern comparator;

FIG. 2 depicts a schematic diagram of one illustrative embodiment of a transaction data simulator 110;

FIG. 3 illustrates a flow chart of one illustrative embodiment of a method 300 of training an intelligent agent;

FIG. 4 illustrates a flow chart of an illustrative embodiment of a method 400 of checking if a cluster of data representative of the transactional behavior of a person or a group of persons has sufficient variability;

FIG. 5 illustrates a schematic block diagram of a system for checking if a cluster of data representative of the transactional behavior of a person or a group of persons has sufficient variability for use in training an intelligent agent; and

FIG. 6 is a block diagram of an example data processing system 600 in which aspects of the illustrative embodiments may be implemented.

### DETAILED DESCRIPTION

The following description is made for illustrating the general principles of the invention and is not meant to limit the inventive concepts claimed herein. In the following detailed description, numerous details are set forth in order to provide an understanding of the system, platform, method, and/or techniques for generating, training, and monitoring trained intelligent agents, also referred to as trained intelligent bots, including providing and/or checking whether clusters of data representative of a person (e.g., an individual or an entity) or a group of persons has sufficient variability for use in training a realistic version of an intelligent agent, however, it will be understood by those skilled in the art that different and numerous embodiments of the system, platform, and/or its method of operation may be practiced without those specific details, and the claims and disclosure should not be limited to the features, aspects, arrangements, structures, systems, assemblies, subassemblies, platforms, architectures, modules, functional units, circuitry, embodiments, programming, processes, methods, techniques, and/or details specifically described and shown herein. Further, particular features, aspects, arrangements, structures, systems, assemblies, subassemblies, platforms, architectures, modules, functional units, circuitry, embodiments, programming, methods, processes, techniques, details, etc. described herein can be used in combination with other described features, aspects, arrangements, structures, systems, assemblies, subassemblies, platforms, architectures, modules, functional units, circuitry, embodiments, programming, techniques, methods, processes, details, etc. in each of the various possible combinations and permutations.

The following discussion omits or only briefly describes conventional features of information processing systems and data networks, including computer-implemented cognitive systems, data analytics programs, deep learning, and/or machine learning systems/programming, which should be apparent to those skilled in the art. It is assumed that those skilled in the art are familiar with data analytics, including large scale cognitive analytics and their operation, the clustering of data for use in such large-scale cognitive analytics, the training and monitoring of intelligent agents and/or bots for simulating behavior, and the application of cognitive analytics, including, for example, analytics systems and processes to monitor and detect suspicious financial activity. It may be noted that a numbered element is numbered according to the figure in which the element is introduced, is typically referred to by that number throughout succeeding figures, and like reference numbers generally represent like parts of the illustrative embodiments of the invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to convey and manipulate data at various levels of interpretation which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection (memorization and recall) from data points (images, text, voice)
Predict and sense with situation awareness that mimics human cognition based on experiences
Answer questions based on natural language and specific evidence

In one aspect, the cognitive system techniques can be applied to create a transaction data simulator, which can simulate a set of transaction data from a financial institution, e.g., a bank. The transaction data simulator in an embodiment combines a multi-layered unsupervised clustering approach with a semi-interactive reinforcement learning (sIRL) model to create a large set of intelligent agents, also referred to as “trained bots”, that are trained to behave like a wide range of persons interacting with and/or performing transactions with financial institutions.

In one or more aspects a system, platform, computer program product, and/or method is disclosed for measuring the variability in pre-determined clusters of behavior for variability and/or entropy, and if the clusters are not “interesting enough”, e.g., do not have sufficient variability of behavior, clusters are modified and/or merged to provide improved clusters of behavior for use in training the intelligent agents. In one or more approaches, the clusters are inspected, reviewed, and/or analyzed, and in instances where a cluster does not exhibit enough variability the cluster is modified and/or merged to improve the variability of behavior for that cluster.

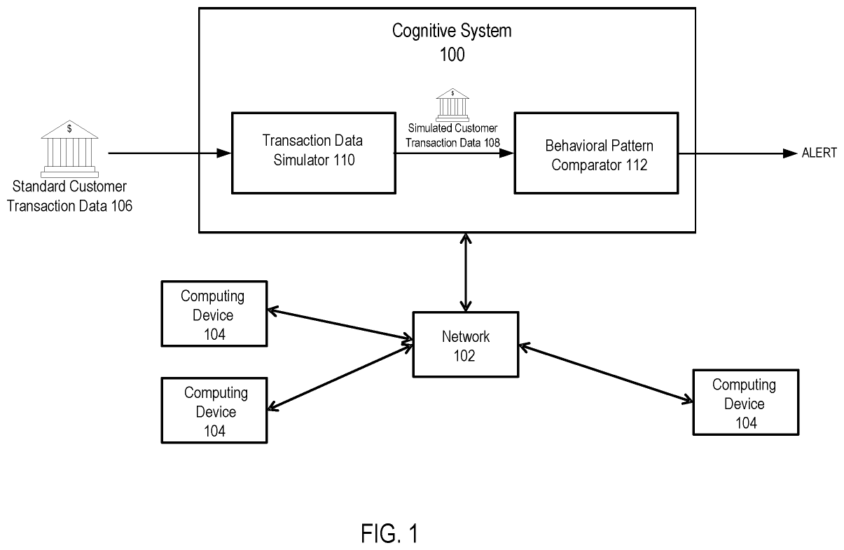

FIG. 1 depicts a schematic diagram of one illustrative embodiment of a cognitive system 100 implementing transaction data simulator 110, and a behavioral pattern comparator 112. The cognitive system 100 is implemented on one or more computing devices 104 (comprising one or more processors and one or more memories, and potentially any other computing device elements generally known in the art including buses, storage devices, communication interfaces, and the like) connected to computer network 102. The computer network 102 typically includes multiple computing devices 104 in communication with each other and with other devices or components via one or more wired and/or wireless data communication links, where each communication link comprises one or more of wires, routers, switches, transmitters, receivers, or the like. Other embodiments of the cognitive system 100 may be used with components, systems, sub-systems, and/or devices other than those that are depicted herein. The computer network 102 can include local network connections and remote connections in various embodiments, such that the cognitive system 100 can operate in environments of any size, including local and global environments, e.g., through the Internet.

The cognitive system 100 in one or more embodiments is configured to implement transaction data simulator 110 that can simulate or intake sets of transaction data 106, e.g., client/customer transaction data 106. In an embodiment, the set of transaction data 106 is obtained through an unsupervised clustering approach. Raw data including a large amount of transaction data 106 is provided by one or more banks, and a large set of small groups representing different characteristics of bank customers are clustered or grouped from the raw data through an unsupervised clustering approach described in greater detail herein. The transaction data 106 is used to create groups or clusters of people who behave similarly, and preferably behave and perform like individual clients/customers/entities/individuals. Each small group or cluster includes transaction data from persons having similar characteristics. A cluster can represent in an embodiment a set of transactional behavior parameters. For example, group A represents persons who are single attorneys practicing patent law in New York, while group B represents persons who are married attorneys practicing commercial law in New York.

The transaction data simulator 110 can generate a large set of simulated transaction data 108 based on the superset of transaction data 106 so that the simulated transaction data 108, e.g., simulated customer transaction data 108, looks like real transaction data. The simulated transaction data 108 in an embodiment is then combined with a randomly selected artificial profile, so that complete simulated profile data for a simulated person, e.g., simulated customer, is obtained.

In an aspect, trained intelligent agents, also referred to as a trained bots, are run to predict transactions of a person (or clustered group of persons) to create simulated transaction behavior 108. In an embodiment, a Behavioral Pattern Comparator 112 is also implemented in the Cognitive System 100. The Behavioral Pattern Comparator 112 can compare the simulated transaction data 108 provided by the transactional data simulator 110, and more particularly the predicted behavior of a simulated person as generated and/or represented by a trained intelligent agent, also referred to as a trained bot, can be compared to the actual transactional behavior of a person, e.g., a customer). In an embodiment, if the confidence score/level of one or more transactions of the actual person/entity deviates from the confidence score/level of the “simulated” behavior 108 of the actual trained intelligent agent, then an alert can be generated indicating possible suspicious activity (e.g., a suspicious transaction).

The Behavior Pattern Comparator 112 has instructions, logic, and algorithms that, when executed by a processor, cause the processor to perform the actions and operations discussed in connection with the Behavioral Pattern Comparator 112. While the Behavior Pattern Comparator 112 has been shown as a separate module in Cognitive System 110, it can be appreciated that Behavior Pattern Comparator 112, or the activities and actions performed by the Behavior Pattern Comparator 112 can be part of and/or integral with the Transaction Data Simulator 110.

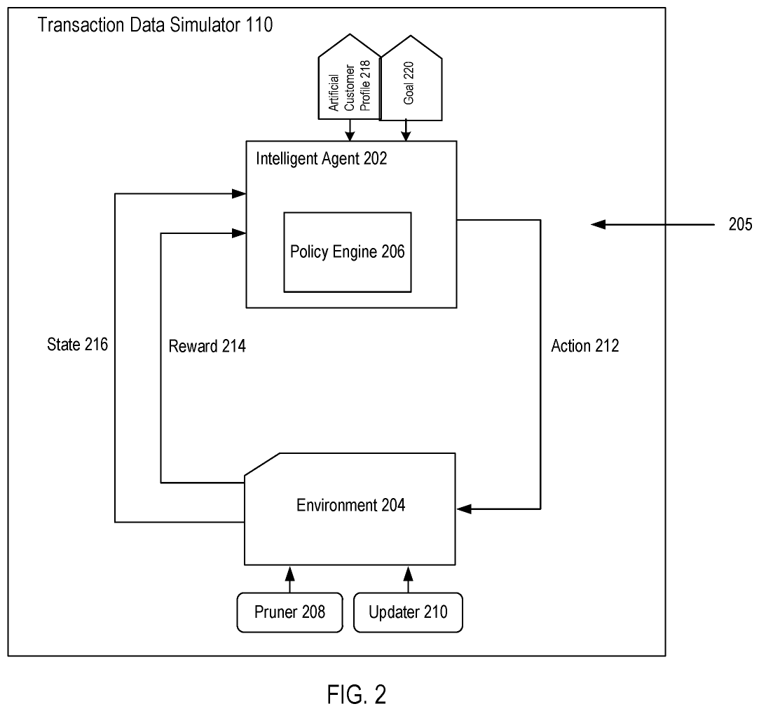

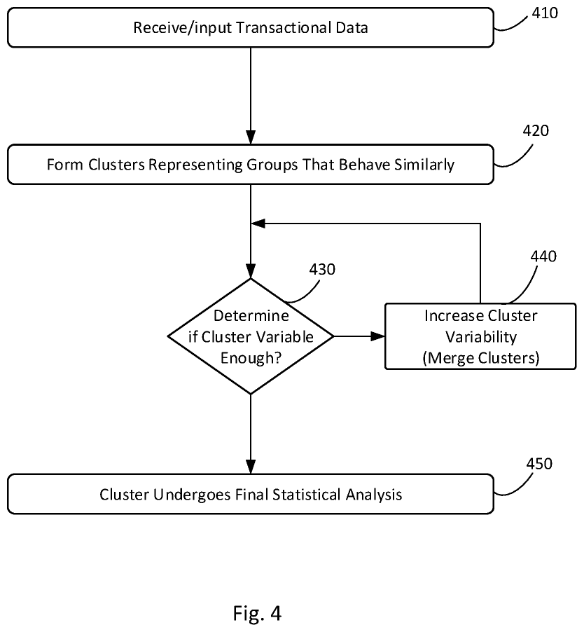

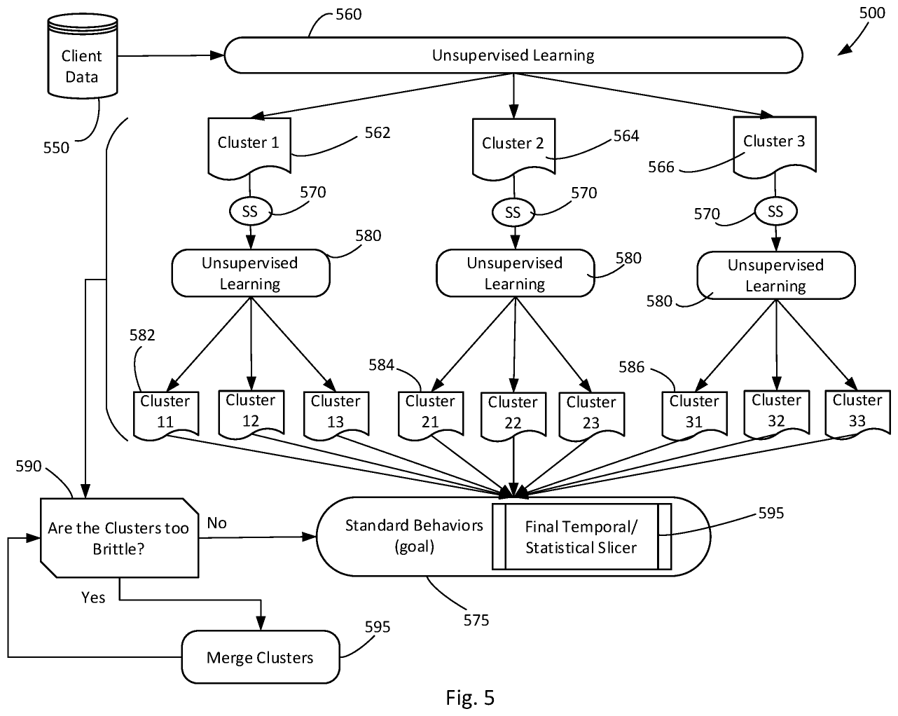

FIG. 2 depicts a schematic diagram of one illustrative embodiment of the Transaction Data Simulator 110. The transaction data simulator 110 utilizes reinforcement learning techniques to simulate financial transaction data. The transaction data simulator 110 includes intelligent agent 202, and environment 204. The intelligent agent 202 randomly selects a derived standard transaction behavior 220 (e.g., goal 220) representing a set of “persons”, e.g., “customers”, having similar transaction characteristics, and associates the standard transaction behavior with a randomly selected artificial profile 218. Obtaining the standard transaction behavior 220 (e.g., the goal 220) representing a set of “persons” having similar transaction characteristics, e.g., the cluster representing the group of customers that behave similarly (like an individual customer) is described in more detail in connection with FIGS. 4 and 5.

For the selected cluster or group, the intelligent agent 202 outputs, determines, and/or takes an action 212 in each iteration. In this embodiment, the action 212 taken in each iteration includes determining whether any transactions will be conducted on a single day, e.g., twenty-four hours, and if so, conducting a plurality of transactions on that day. The iteration then continues onto the next day in the series. Each transaction has the transaction information including transaction type (e.g., Automated Clearing House (ACH) transfer, check payment, wire transfer, Automated Teller Machine (ATM) withdrawal, Point of Sale (POS) payment, etc.); transaction amount; transaction time; transaction location; transaction medium (e.g., cash, credit card, debit card, PayPal®, checking account, etc.); the second party who is related to the transaction (e.g., a person who receives the wire transferred payment), and the like.

The environment 204 takes the action 212 as input, and returns reward 214, also referred to as feedback, and state 216 from environment 204 as the output. The reward 214 is the feedback that measures the relative success or failure of the action 212. In an embodiment, the environment 204 compares the action 212 with goal 220 (e.g., standard transaction behavior). If the action 212 deviates from the goal 220 beyond a threshold, then the intelligent agent 202 is penalized relative to the deviation, while if the action 212 is within a threshold of the goal 220 (i.e., the action 212 is similar to the goal 220), the intelligent agent 202 is rewarded. This can include even the decision by the intelligent agent as to whether or not to conduct transactions at all on a given day. The threshold can be predefined, predetermined, fixed, selectable, adjustable, programmable, learned and/or combinations thereof. The action 212 is effectively evaluated, so that the intelligent agent 202 can improve the next action 212 based on the reward 214. In this embodiment, the environment 204 is a set of all prior actions taken by the intelligent agent 202, i.e., the environment 204 is a set of all prior simulated transactions. The intelligent agent 202 observes the environment 204, and gets information about the prior transactions, e.g., the number of transactions that have been made within a day, a week, a month, or a year; each transaction amount, account balance, each transaction type, and the like. The policy engine 206 can adjust the policy based on the observations, so that the intelligent agent 202 can take a better action 212 in the next iteration.

The intelligent agent 202 in an aspect includes policy engine 206, configured to adjust a policy based on the state 216 and the reward 214. The policy is a strategy that the intelligent agent 202 employs to determine the next action 212 based on the state 216 and the reward 214. The policy is adjusted, aiming to get a higher reward 214 for the next action 212 taken by the intelligent agent 202. The policy includes a set of different policy probabilities or decision-making probabilities which can be used to decide whether a transaction is going to be performed in a particular day or not, the number of transactions per day, transaction amount, transaction type, transaction party, etc.

In a reinforcement learning model, outcome of events are stochastic, and a random number generator (RNG) is a system that generates random numbers for use in the stochastic model. In an example, the maximum number of transactions per day is 100, and the maximum transaction amount is $15 million. In the first iteration, a random transaction with transaction amount of $15 million to Zimbabwe is made by the intelligent agent 202. This action 212 deviates far from the goal 220 (e.g., transaction made by married attorneys practicing commercial law in New York), and thus this action 212 is penalized (i.e., the reward 214 is negative). The policy engine 206 is trained to adjust the policy, so that a different transaction which is closer to the goal 220 can be made. A RNG stochastic model is used in reinforcement learning because it facilitates and enables the policy to allow “exploration” by the intelligent agent, rather than getting “stuck” on simple transaction generation patterns that avoids penalty in the feedback system. With more iterations, transactions that are similar to the goal 220 can be simulated by the “smarter” policy engine 206.

As shown in FIG. 2, in an embodiment, one feedback loop (i.e., one iteration) corresponds to one “day” of actions (i.e., one “day” of simulated transactions). During a period of time, e.g., ten years, the intelligent agent 202 learns how to take a “daily” action 212 to get a reward 214 as high as possible. The number of iterations corresponds to the duration of time. For example, ten years correspond to 10×365=3650 iterations. Semi-supervised human interaction 205 can observe and judge the actions 212 by the results that the actions 212 produce, at varying preset intervals, e.g., 10,000 iterations. It is goal 220 oriented, and its aim is to learn sequences of actions 212 that will lead the intelligent agent 202 to achieve its goal 220 or maximize its objective function.

In an embodiment, the transaction data simulator 110 further includes updater 210. A new action 212 is performed in each iteration. The updater 210 updates the environment 204 with the action 212 taken by the intelligent agent 202 after each iteration. The action 212 taken in each iteration is added into the environment 204 by the updater 210. In an embodiment, the transaction data simulator 110 further includes pruner 208, configured to prune the environment 204. In an embodiment, the pruner 208 can remove one or more undesired actions. For example, actions 212 which are taken in the first ten iterations are removed, because these ten iterations deviate far from the goal 220, and the degree of similarity is below a predefined threshold. In another embodiment, a full re-initialization of the transaction data simulator 110 can be performed to remove all the accumulated actions in the environment 204, so that the intelligent agent 202 can start over again.

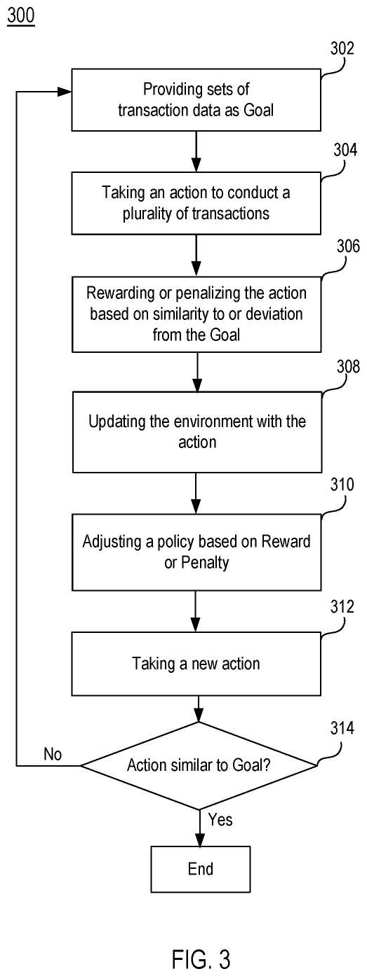

FIG. 3 illustrates a flow chart of one illustrative embodiment showing a method 300 of training an intelligent agent to produce simulated or predicted transaction data. While the method 300 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 3, but the process may be integrated and/or one or more steps may be performed together, simultaneously, or the steps may be performed in the order disclosed or in an alternate order.

At step 302, sets of transaction data are provided as goal 220. The sets of transaction data represent a group of persons having similar transaction characteristics. The sets of transaction data, e.g., transactions, are obtained through an unsupervised clustering approach. In one or more embodiments the unsupervised clustering approach undergoes a process of checking the variability and/or entropy of the clusters representing the groups of persons having similar transaction characteristics, and in an aspect checking whether one or more clusters meet a minimum standard of variability to produce an “interesting” standard behavior pattern, which will be described in more detail in connection with FIGS. 4 & 5.

At step 304, an action 212 is taken to conduct for example, one or more transactions in an iteration, e.g., 100 transactions per iteration. Each iteration can represent a time period, e.g., a single day. Other time periods are contemplated. Each transaction has the transaction information including transaction type, transaction amount, transaction time, transaction location, transaction medium, the second party who is associated with the transaction (if applicable), and the like.

At step 306, the environment 204 compares the goal 220 with the action 212 taken in this iteration, rewards or penalizes the action 212 based on its similarity to or deviation from the goal 220. The threshold or rule to decide whether the action 212 is similar to the goal 220 or not, is predefined, and can be adjusted based on how similar to the goal 220 the user prefers. The threshold can be predetermined, predefined, fixed, programmable, adjustable, and/or machine learned. At step 308, the environment 204 is updated to include the action 212, e.g., the one or more transactions, in the present iteration. The environment 204 includes a set of all prior actions.

At step 310, the policy engine 206 adjusts a policy for determining the next action 212 based on the reward 214 (i.e., reward or penalty). The policy is made based on a variety of factors, e.g., probability of occurrence of a transaction, the number of transactions per day, transaction amount, transaction type, transaction party, transaction frequency of each transaction type, an upper bound and a lower bound for each transaction, transaction medium, and the like. The policy can adjust weights of these factors based on the reward 214 in each iteration.

At step 312, in a new iteration, the intelligent agent 302 takes a new action 312. The steps 304 to 312 are repeated until the action 312 is similar enough to the goal 220 (step 314). For example, the transaction amount specified in the goal 220 is $20-$3000. If the transaction amount of each transaction in the action 212 falls within the range of $20-$3000, then the action 212 is similar enough to the goal 220. A further optional step can include combining the artificial profile with the last action 212 including a plurality of transactions similar enough to the goal, so that simulated data (e.g., person/customer behavior) is generated. In this manner a trained intelligent agent, e.g., a trained bot, is produced and/or generated.

While FIGS. 2 & 3 discuss a system and method to train an intelligent agent and determine whether transactional behavior deviates from the norm and might be considered suspicious for further review, it will be appreciated that other systems and/or methods are contemplated for training an intelligent agent and/or determining whether transactional activity is suspicious.

FIG. 4 illustrates a flow chart of an illustrative embodiment showing a method 400 of obtaining sets of transaction data representative of a person (e.g., an individual or an entity) or a group of persons having similar transaction characteristics for use, for example, in training an intelligent agent to produce simulated or predicted transaction data. More specifically method 400 in one or more approaches includes checking a cluster of transactional behavior representing a person or a group of persons to determine whether the cluster exhibits sufficient variability, and in an aspect modifying and/or merging clusters to obtain clusters whose transactional behavior exhibits sufficient variability to facilitate intelligent agent training. While the method 400 is described for the sake of convenience and not with an intent of limiting the disclosure as comprising a series and/or a number of steps, it is to be understood that the process 400 does not need to be performed as a series of steps and/or the steps do not need to be performed in the order shown and described with respect to FIG. 4, but the process 400 may be integrated and/or one or more steps may be performed together, simultaneously, or the steps may be performed in the order disclosed or in an alternate order.

The process 400 of obtaining sets of transactional data representative of a group of persons having similar characteristics for use for example in training an intelligent agent will be described in connection with the flowchart of FIG. 4 and the schematic representation of the system of FIG. 5. FIG. 5 schematically illustrates the supervised learning process to break down the transactional data into clusters representative of different groups of customers that behave like individual customers. At 410 transactional data 550 is received and/or input into system 500. System 500 in an embodiment can be representative of cognitive system 100.

At 420 the data received undergoes an unsupervised learning analysis and technique 560 that breaks the transactional data 550 into a first level of clusters—cluster 1 (562), cluster 2 (564) and cluster 3 (566). It can be appreciated that the number of clusters in the first level of clusters is likely more than just three clusters. A cluster can represent in an embodiment a set of transactional behavior parameters. For example, the transactional behavioral parameters for a cluster can be the minimum and maximum amount of each transaction, how often and/or how many transactions are undertaken in a period of time, the type of parties to the transaction, etc. At 420, after performing unsupervised clustering and breaking the data 550 into various clusters (e.g., clusters 562, 564, & 566), each cluster undergoes statistical analysis using temporal statistical slicer 570 (represented by SS 570 in FIG. 5). The statistical slicer (SS) 570 analyzes the cluster to determine its statistical parameters, such as, for example, the minimum transactional amount, the maximum transactional amount, the minimum number of transactions in a time period, the maximum number of transactions in a time period, and standard deviations.

Each first level of clusters (e.g., 562, 564, 566, etc.) as part of 420 undergoes further unsupervised learning as illustrated in FIG. 5 by unsupervised learning 580. The unsupervised learning of each first level cluster (e.g., a producing or parent cluster) creates and/or breaks down each producing or parent cluster (e.g., 562, 564, 566, etc.) into further child clusters (e.g., second level clusters) as illustrated by representative clusters 582, 584, 586, etc. (e.g., clusters 11, 12, 13, . . . , 21, 22, 23, . . . , 31, 32, 33, . . . , etc.). Each of those second level of (child) clusters undergoes statistical analysis using temporal statistical slicer 570 to determine its statistical parameters. The second level of clusters typically undergoes another round of unsupervised learning to break down each second level cluster into further clusters, and each cluster is statistical analyzed using the statistical slicer 570. This process continues until the data 550 is broken into clusters representing groups of people who behave similarly and behave like individual transacting persons (individuals or entities).

When the data 550 has been analyzed and clustered into groups representing people who behave similarly and like individual transacting persons, each cluster undergoes a final statistical analysis represented by final temporal statistical slicer 570′ in FIG. 5 to provide standard behaviors (goals) 575 for each cluster. The standard behaviors (goals) 575 can be the standard behavior for the cluster including parameters such as the minimum and maximum transaction amounts, the number and frequency of transactions, the parties to the transactions (recipients and providers), etc.

While a first level unsupervised learning 560 is shown in FIG. 5 as resulting in only three producing or parent clusters 562, 564, and 566 it will be appreciated that more than three producing or parent clusters are likely after the first pass at unsupervised learning 560, and likewise more than three child clusters are likely after the second pass of unsupervised learning 580, and the number of clusters that each cluster is further broken down into is not likely the same number for each cluster that is further broken down. Further, while only two levels of unsupervised learning (560, 580) are shown in FIG. 5 it will be appreciated that more levels of unsupervised learning typically are applied to the data/clusters to break the data 550 into groups of people (clusters) that behave similarly and behave like individual transacting persons (individuals or entities). The end result of the unsupervised learning process is typically thousands of clusters, each cluster defined by transactional parameters.

A potential problem with breaking the data down into clusters that are representative of customers that behave similarly and down to the granularity of individual customers is that there may not be sufficient variability in the data for those clusters to be meaningful, which can affect the effectiveness of the clusters as being representative of transactional behavior of persons. In one or more approaches, at 430 a cluster is inspected and/or analyzed to determine if the cluster (e.g., the cluster parameters) has sufficient variability. As shown in FIG. 5, the cluster under review is checked at 590 to determine whether the cluster is too brittle, e.g., is too narrow (does not have enough variability and/or entropy). While there may be one or more manners of determining the variability of a cluster, one way to determine if there is sufficient variability is to inject data into the cluster that is, for example, half a standard deviation off a normalized set of the current cluster and parent cluster, and determine if the injected transaction falls withing the parameters of the current cluster. That is, a series of statistical analyses and normalization functions are performed to create a comparable “superset” containing both the current cluster and the parent cluster, wherein the newly created superset is used as a baseline to create test data (e.g., data that is half a standard deviation off) that is injected into the new cluster for evaluation. If the new cluster rejects the injected data, then the cluster is “too brittle”.

If it is determined at 430 that the cluster is sufficiently variable (430: Yes) then the process continues to 450 where if the cluster has not undergone final statistical analysis, using for example final temporal statistical slicer 570′, the cluster undergoes final statistical analysis using final temporal statistical slicer 570′ to determine and/or generate the standard behavior (goal) 575 for the cluster. If on the other hand, it is determined at 430 that the cluster under review does not exhibit sufficient variability (430: No), then process 430 continues to 440 where in one or more embodiments further processing is undertaken to add variability and/or entropy to the cluster.

A cluster that does not exhibit enough variability is typically considered to be too narrow, and can in instances be referred to as being too “brittle”. In one or more approaches at 440, to introduce increased variability to a cluster that is too narrow, one or more clusters resulting from the unsupervised clustering that are not under review and/or inspection for being too narrow are merged with (e.g., added to) the cluster under review. For example, if cluster 11 in FIG. 5 has been determined to be too narrow (e.g., too brittle) at 590 (590: Yes), then cluster 11 is merged at 595 with another cluster, for example any one of clusters 12, 13, 21, 22, 23, 31, 32, 33, etc.

The manner in which a cluster that is too narrow is merged with one or more other clusters to make its data more variable can be performed in a number of varying methods. In one or more approaches, the cluster that is too narrow can be merged with one of more clusters that resulted from the cluster that produced the cluster that is too narrow (referred to as the producer cluster). For example, cluster 11 (produced from and/or generated as a result of cluster 1) would be merged with cluster 12 and/or 13, which both result from the same producer cluster 1 that produced cluster 11. The system and/or technique can select the cluster resulting from the producer cluster that has the greatest variability/entropy. For example, in the example where cluster 11 is to be merged with cluster 12 or 13, the system and/or technique would choose between clusters 12 and 13 by determining/choosing which of clusters 12 or 13 has the greatest variability/entropy, and merging the cluster with the greatest variability with the cluster under review to form a new cluster with greater variability/entropy.

In response to 440 where variability was added to the cluster that is determined to be too narrow, for example by merging with another cluster (at 595 in FIG. 5), process 400 continues back to 430 where the variability of the cluster is reviewed and/or analyzed to determine if the new cluster is sufficiently variable. For example, where cluster 11 is merged at 440 with cluster 12 to be new cluster 11A, then cluster 11A is tested at 430 to determine if it is sufficiently variable. If at 430, the new merged cluster 11A is sufficiently variable, then the new cluster 11A proceeds to 450 where the new cluster 11A undergoes final statistical analysis, for example using final temporal statistical slicer 570′ to obtain standard behaviors (goal) 575. If on the other hand the new merged cluster 11A is not sufficiently variable (430: No), e.g., the cluster 11A is too brittle at 590 in FIG. 5, then the process continues to 440 (595 in FIG. 5) where the variability of the new merged cluster 11A is merged with yet another cluster, preferably a cluster resulting from the producing cluster (e.g., cluster 1). For example, merged cluster 11A would further be merged with cluster 13 to form a new cluster (e.g., cluster 11A′). Merged cluster 11A′ would be tested pursuant to 430 (590 in FIG. 5) to determine if new merged cluster 11A′ is sufficiently variable, and the process 400 would continue until a cluster of sufficient variability is generated.

There could become a point where after several rounds of merging clusters or changing the cluster to increase variability, a cluster of sufficient variability, according to, for example the standard set at 430, is still not produced. In such a case, the cluster that was originally tested (e.g., cluster 11), which could then be merged cluster 11A′, would in an embodiment be dropped as a cluster. In a further embodiment, the merged cluster, or the original cluster can forced to be variable by changing the parameters of the cluster. It should be recognized that force changing the parameters should be a step of last resort when nothing else works.

The process 430, 440, 450 would be performed for each cluster to obtain standard behaviors for all the clusters formed in step 420 or that were formed as a result of step 440. That is, preferably the variability for each cluster is checked to determine if it is sufficiently variable (e.g., has sufficient variability to be meaningful), and/or is modified in such cases to increase variability.

It will be understood that one or more blocks of the flowchart illustrations in FIGS. 3, 4 & 5 and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions, and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

In an embodiment, the multi-layered unsupervised clustering approach creates a large set of varying representative sets of transactions (e.g., extracted from real transaction data provided by a financial institution), using information including hundreds of attributes of persons, e.g., customers, over varying lengths of time. Each set of the sets of transactions in one or more embodiments can be associated with a group of persons having similar transaction characteristics. A trained intelligent agent or trained bot, in an embodiment generates an artificial profile, e.g., an artificial customer profile, and selects one of a number of sets of transaction behaviors of people to be combined with a generated artificial profile. In this way, the intelligent agent or trained bot can simulate that set of persons, and learn to behave as though it were a person that would have fit into that set of persons. The intelligent agent or trained bot is then provided with a period of time (e.g., five years), during which the intelligent agent can observe the person's data within a controlled environment, e.g., past behaviors of the represented set of persons, and learn to perform “simulated” transactions, which are similar to standard transactions (behavior) of the represented set of standard persons.

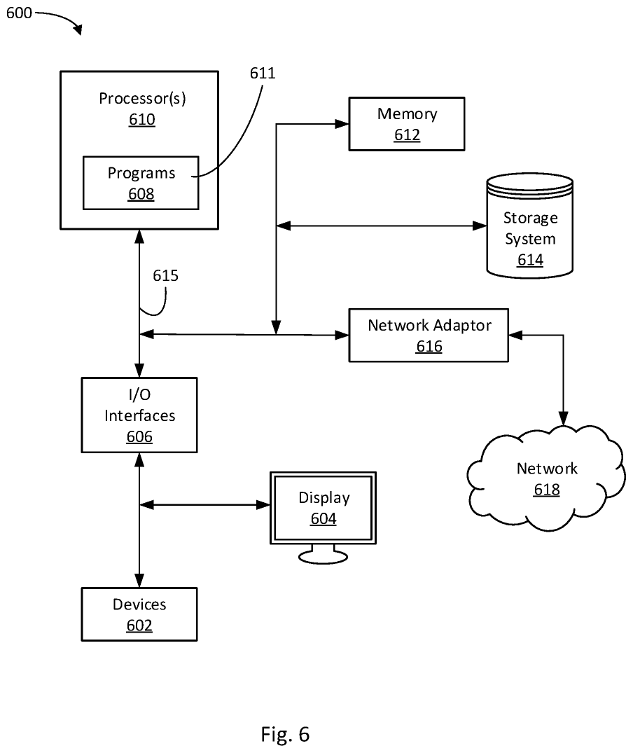

FIG. 6 illustrates an example computing and/or data processing system 104 in which aspects of the present disclosure may be practiced. It is to be understood that the computer and/or data processing system 104 depicted is only one example of a suitable system and is not intended to suggest any limitation as to the scope of use or functionality of embodiments of the present invention. For example, the system shown may be operational with numerous other special-purpose computing system environments or configurations. Examples of well-known computing systems, environments, and/or configurations that may be suitable for use with the system shown in FIG. 6 may include, but are not limited to, server computer systems, mainframe computers, distributed cloud computer systems, personal computer (PC) systems, PC networks, thin clients, thick clients, minicomputer systems, handheld or laptop devices, multiprocessor systems, microprocessor-based systems, smart phone, set top boxes, programmable consumer electronics, and the like that include any of the above systems or devices, and the like.

In some embodiments, the computer system 104 may be described in the general context of computer system executable instructions, embodied as program modules stored in memory 612, being executed by the computer system. Generally, program modules may include routines, programs, objects, components, logic, data structures, and so on that perform particular tasks and/or implement particular input data and/or data types in accordance with the present invention.

The components of the computer system 104 may include, but are not limited to, one or more processors or processing units 610, a memory 612, and a bus 615 that operably couples various system components, including memory 612 to processor 610. In some embodiments, the processor 610, which is also referred to as a central processing unit (CPU) or microprocessor, may execute one or more programs or modules 608, e.g., cognitive system 100, that are loaded from memory 612 to local memory 611, where the program module(s) embody software (program instructions) that cause the processor to perform one or more operations. In some embodiments, module 608 may be programmed into the integrated circuits of the processor 610, loaded from memory 612, storage device 614, network 102 and/or combinations thereof to local memory 611.

The processor (or CPU) 610 can include various functional units, registers, buffers, execution units, caches, memories, and other units formed by integrated circuitry, and may operate according to reduced instruction set computing (“RISC”) techniques. The processor 610 processes data according to processor cycles, synchronized, in some aspects, to an internal clock (not shown). Bus 615 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computer system 104 may include a variety of computer system readable media, including non-transitory readable media. Such media may be any available media that is accessible by the computer system, and it may include both volatile and non-volatile media, removable and non-removable media.

Memory 612 (sometimes referred to as system or main memory) can include computer readable media in the form of volatile memory, such as random-access memory (RAM), cache memory and/or other forms. Computer system 104 can further include other removable/non-removable, volatile/non-volatile computer system storage media. By way of example only, storage system 614 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 615 by one or more data media interfaces.

The computer system may also communicate with one or more external devices 602 such as a keyboard, track ball, mouse, microphone, speaker, a pointing device, a display 604, etc.; one or more devices that enable a user to interact with the computer system; and/or any devices (e.g., network card, modem, etc.) that enable the computer system to communicate with one or more other computing devices. Such communication can occur via Input/Output (I/O) interfaces 606. Communications or network adapter 616 interconnects bus 615 with an outside network 102 enabling the data processing system 104 to communicate with other such systems. Additionally, an operating system such as, for example, AIX (“AIX” is a trademark of the IBM Corporation) can be used to coordinate the functions of the various components shown in FIG. 6.

The computer system 104 can communicate with one or more networks 102 such as a local area network (LAN), a general wide area network (WAN), and/or a public network (e.g., the Internet) via network adapter 616. As depicted, network adapter 616 communicates with the other components of computer system via bus 615. It should be understood that although not shown, other hardware and/or software components could be used in conjunction with the computer system. Examples include, but are not limited to: microcode, device drivers, redundant processing units, external disk-drive arrays, RAID systems, tape drives, and data archival storage systems, etc.

Those of ordinary skill in the art will appreciate that the hardware depicted in FIG. 6 may vary depending on the implementation. Other internal hardware or peripheral devices, such as flash memory, equivalent non-volatile memory, or optical disk drives may be used in addition to or in place of the hardware depicted. Moreover, the data processing system 104 can take the form of any of a number of different data processing systems, including but not limited to, client computing devices, server computing devices, tablet computers, laptop computers, telephone or other communication devices, personal digital assistants, and the like. Essentially, data processing system 104 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112 (f), unless the element is expressly recited using the phrase “means for.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java™, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor, functional units of a processor, or computer implemented system, and logic integrated with and/or executable by the system, processor, or functional units, the logic being configured to perform one or more of the process steps cited herein. What is meant by integrated with is that in an embodiment the functional unit or processor has logic embedded therewith as hardware logic, such as an application specific integrated circuit (ASIC), a field programmable gate array (FPGA), etc. By executable by the functional unit or processor, what is meant is that the logic in an embodiment is hardware logic; software logic such as firmware, part of an operating system, part of an application program; etc., or some combination of hardware or software logic that is accessible by the functional unit or processor and configured to cause the functional unit or processor to perform some functionality upon execution by the functional unit or processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above. If will be further appreciated that embodiments of the present invention may be provided in the form of a service deployed on behalf of a customer to offer a service on demand.

The terminology used herein is for the purpose of describing particular embodiments only and is not intended to be limiting of the invention. Unless otherwise specifically defined herein, all terms are to be given their broadest possible interpretation including meanings implied from the specification as well as meanings understood by those skilled in the art and/or as defined in dictionaries, treatises, etc. The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A computer-implemented method for checking that clusters representative of transactional activity exhibit sufficient variability comprising a processor and a memory having instructions, which are executed by the processor to cause the processor to implement the method, the method comprising:
receiving transactional data;
forming clusters from the received transactional data that represents similar transactional behavior;
determining that a formed cluster is not sufficiently variable; and
increasing, in response to the formed cluster not being sufficiently variable, the variability of the cluster.

2. The method as recited in claim 1, wherein forming clusters from the received transactional data that represents similar transactional behavior comprises performing an unsupervised learning analysis process on the received transactional data.

3. The method as recited in claim 2, further comprising performing multiple unsupervised learning analysis processes including performing an unsupervised learning analysis process on one or more clusters.

4. The method recited in claim 1, wherein determining that a formed cluster is not sufficiently variable comprises:
creating a superset cluster consisting of both the cluster and the parent of the cluster by performing a series of statistical analyses and normalization functions;
creating test data using the superset as a baseline;
injecting the test data into the superset cluster;
determining if the superset cluster rejects the injected test data; and
rejecting, in response to the superset rejecting the injected test data, the cluster as not sufficiently variable.

5. The method as recited in claim 1, further comprising performing final statistical analysis on each of the clusters.

6. The method as recited in claim 1, wherein increasing the variability of the cluster further comprises merging the cluster with another, different cluster.

7. The method as recited in claim 6, wherein the another, different cluster is selected from a group of clusters that are formed from a parent cluster of the cluster.

8. The method as recited in claim 7, wherein the another, different cluster is selected to have the greatest variability.

9. The method as recited in claim 6, wherein increasing the variability of the cluster further comprises merging with multiple different clusters.

10. The method as recited in claim 1, further comprising using the clusters with increased variability to train intelligent agents used to simulate the transactional behavior of at least one of a group consisting of a person and a group of persons.

11. The method as recited in claim 1, wherein each cluster has parameters including a minimum transactional amount, a maximum transactional amount, a minimum number of transactions in an iteration; and a maximum number of transactions in the iteration.

12. The method as recited in claim 1, wherein the cluster having insufficient variability is dropped as a cluster.

13. The method as recited in claim 1, further comprising determining that a cluster has sufficient variability and performing final statistical analysis of the cluster.

14. A computer program product for checking whether a cluster representing transactional activity of a person or group of persons has sufficient variability, the computer program product comprising a computer readable storage medium having program instructions embodied therewith, the program instructions executable by a processor to cause the processor to:
receive transactional data;
form clusters from the received transactional data, wherein each cluster represents similar transactional behavior;
determine that a formed cluster is not sufficiently variable; and
increase, in response to the formed cluster not being sufficiently variable, the variability of the cluster.

15. The computer program product as recited in claim 14, wherein programming instructions executable to cause the processor to form clusters from the received transactional data further comprising programming instructions that when executed by the processor cause the processor to perform a hyperdimensional unsupervised learning process on the received transactional data.

16. The computer program product as recited in claim 14, wherein programming instructions executable to cause the processor to determine that a formed cluster is not sufficiently variable further comprising program instructions executable by the processor to cause the processor to:
create a superset cluster consisting of both the cluster and the parent of the cluster by performing a series of statistical analyses and normalization functions;
create test data using the superset cluster as a baseline;
inject the test data into the superset cluster;
determine if the superset cluster rejects the injected test data; and
reject, in response to the superset rejecting the injected test data, the cluster as not sufficiently variable.

17. The computer program product as recited in claim 14, wherein programming instructions that when executed by the processor cause the processor to increase the variability of the cluster further comprises programming instructions executable by the processor to cause the processor to merge the cluster with at least another, different cluster.

18. The computer program product as recited in claim 14, further comprises programming instructions executable by the processor to cause the processor to:
perform final statistical analysis on each of the clusters; and
using at least the clusters with increased variability to train intelligent agents to simulate the transactional behavior of a person or a group of persons.

19. A system for increasing the variability in clusters formed to represent transactional activity, the system comprising:
a computer readable non-transitory storage medium having program instructions embedded therewith; and
a processor configured to execute said program instructions to cause the processor to:
receive transactional data;
form, using an unsupervised learning process, clusters from the received transactional data that represent similar transactional behavior;
determine that a formed cluster is not sufficiently variable;
increase, in response to each formed cluster that is not sufficiently variable, the variability of each such cluster that is not sufficiently variable; and
perform statistical analysis of each formed cluster.

20. The system of claim 19, wherein the program instructions executable by the processor to cause the processor to determine that a formed cluster is not sufficiently variable further comprises instructions executable by the processor to cause the processor to:
create a superset cluster consisting of both the cluster and the parent of the cluster by performing a series of statistical analyses and normalization functions;
create test data that is half a standard deviation off of the superset cluster;
injecting the test data into the superset cluster;
determining if the superset cluster rejects the injected test data; and
rejecting, in response to the superset rejecting the injected test data, the cluster as not sufficiently variable; and
wherein the program instructions executable by the processor to cause the processor to increase the variability of each such cluster that is not sufficiently variable further comprises programming instructions executable by the processor to cause the processor to merge each such cluster that is not sufficiently variable with at least another, different cluster.
